(19) United States
(12) Patent Application Publication
(10) Pub. No.: US 2004/0210881 A1
(43) Pub. Date: Oct. 21, 2004

(54) Method of generating an application program interface for resource description framwork (RDF) based information

(76) Inventors: Richard Friedman, Cherry Hill, NJ (US); Joseph J. Snyder, Shamong, NJ (US); Jason A. Kinner, Marlton, NJ (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/417,737

(22) Filed: Apr. 17, 2003

(51) Int. Cl. G06F 9/45

(52) U.S. Cl. 717/140

(57) ABSTRACT

The specification may disclose a method of reading, by a compiler program, a Resource Description Framework (RDF) based input source and generating implementation by the compiler to access information coded based on the RDF model.

### BACKGROUND

Resource Description Framework (RDF), as defined by the World Wide Web Consortium (W3C), may be a model for storing information. More particularly, the RDF model may be designed for storing of information about information—METADATA. METADATA in the RDF model is grouped using a logical triple. In its simplest form, the triple may comprise a subject, a predicate and an object. For example, the statement “Leslie is 34 years old” may be broken down into the triple subject=Leslie, predicate=age, and object=“34.” Thus, the predicate that links the subject “Leslie” to the object “34” may be the property ‘age.’ In more technical jargon, the triple of the RDF model may be defined by a resource (subject), property (predicate), and object. Although the resource in the simple example given above was “Leslie,” in the RDF model a resource may be anything which may be assigned a Universal Resource Identifier (URI). One example of the resource that may be assigned an URI is a document posted to the world-wide web. A document with a URI may be as simple as a digital image, or may be as complex as a series of commands read by a web browser to create a viewable web page.

The RDF model may not define properties or predicates; rather, the RDF model may only define the relationship of storing METADATA in the form of a triple. Thus, the general population may be free to define any series of properties which may be relevant to their particular genre of subjects. Each of these defined set of properties may be referred to as a schema, a RDF schema, or a “namespace.”

Although the general population may be free to define RDF schemas, there are previously defined, and publicly available, schemas for particular resources. For example, one organization has created the Dublin Core METADATA schema directed to properties of internet documents, such as web documents viewable with a web browser, pictures posted to the web, and the like. The Dublin Core schema may define fifteen properties, such as title, author, publisher, other agent (such as editors, transcribers or illustrators who have made significant intellectual contribution), date, object type, and the like. However, other schemas may be created in which properties, though facially the same, have different meanings. Thus, for example, under the Dublin Core schema ‘Date’ may have a particular meaning, namely, the date of publication. Under other schemas, ‘Date’ may be defined in other ways, such as date of creation of the work.

The RDF model, as well as the various schema that have been produced or may be produced, may not be a programming language. Rather, METADATA information may be coded in eXtensible Markup Language (XML). Programmers may access the information coded in XML by hand coding programs in various other programming languages, such as Java, C++, C# (C sharp), and the like. However, to access the METADATA from a database coded using the RDF model, a programmer may need to know the schema, or schemas, that may be used in the database created under the RDF model. Thus, before a programmer may access METADATA in RDF format, significant time may be required to ascertain the schema or schemas used, and to code programs to access that information.

### BRIEF SUMMARY OF SOME OF THE EMBODIMENTS OF THE INVENTION

The specification may disclose a method comprising reading a RDF based input source by a compiler, and generating a set of implementations by the compiler based on the RDF based input source.

The specification may also disclose a computer readable media comprising an executable program that, when executed, implements a method such as reading a Resource Description Framework (RDF) based input source, generating a list of routines based on properties of the RDF leveraged input source, and generating a set of routines based on the properties of the RDF based input source.

### BRIEF DESCRIPTION OF THE DRAWINGS

For a detailed description of representative embodiments, reference will now be made to the accompanying drawings in which:

FIG. 1 illustrates a block diagram implementation of representative embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be exemplary of that embodiment, and not intended to intimate that the scope of the disclosure, including the claims, is limited to that embodiment.

As mentioned in the Background section, there may already be defined several schemas, such as the Dublin Core (DC) schema. The DC schema may define fifteen properties related to METADATA about web-based documents. The following table may list the fifteen properties as the DC schema was defined at a particular point in time.

TABLE 1

| Property | Description |
|---|---|
| Title | The name given to the resource, usually by the Creator or |
| | Publisher. |
| Author or | The person or organization primarily responsible for |
| Creator | creating the intellectual content of the resource. For |
| | example, authors in the case of written documents, artists, |
| | photographers, or illustrators in the case of visual |
| | resources. |
| Subject and | The topic of the resource. Typically, subject will be |
| Keywords | expressed as keywords or phrases that describe the |
| | subject or content of the resource. |
| Description | A textual description of the content of the resource, |
| | including abstracts in the case of document-like objects or |
| | content descriptions in the case of visual resources. |
| Publisher | The entity responsible for making the resource available |
| | in its present form, such as a publishing house, a |
| | university department, or a corporate entity. |
| Other | A person or organization not specified in a Creator |
| Contributor | element who has made significant intellectual |
| | contributions to the resource but whose contribution is |
| | secondary to any person or organization specified in a |
| | Creator element (for example, editor, transcriber, and |
| | illustrator). |
| Date | A date associated with the creation or availability of the |
| | resource. Includes (among others) dates of the forms |
| | YYYY and YYYY-MM-DD. |
| Resource | The category of the resource, such as home page, novel, |
| Type | poem, working paper, technical report, essay, dictionary. |
| | For the sake of interoperability, Type should be selected |
| | from an enumerated list that is under development in the |
| | workshop series. |
| Format | The data format and, optionally, dimensions (e.g., size, |
| | duration) of the resource. The format is used to identify |
| | the software and possibly hardware that might be needed |
| | to display or operate the resource. |
| Resource | A string or number used to uniquely identify the resource. |
| Identifier | Examples for networked resources include URLs and |
| | URNs (when implemented). Other globally-unique |
| | identifiers, such as International Standard Book Numbers |
| | (ISBN) or other formal names would also be candidates |
| | for this element. |
| Source | Information about a second resource from which the |
| | present resource is derived. |
| Language | The language of the intellectual content of the resource. |
| Relation | An identifier of a second resource and its relationship to |
| | the present resource. This element is used to express |
| | linkages among related resources. |
| Coverage | The spatial and/or temporal characteristics of the |
| | intellectual content of the resource. Spatial coverage |
| | refers to a physical region (e.g., celestial sector) using |
| | place names or coordinates (e.g., longitude and latitude). |
| | Temporal coverage refers to what the resource is about |
| | rather than when it was created or made available (the |
| | latter belonging in the Date element). Temporal coverage |
| | is typically specified using named time periods (e.g., |
| | Neolithic) or the same date/time format. |
| Rights | A rights management statement, an identifier that links to |
| Management | a rights management statement, or an identifier that links |
| | to a service providing information about rights |
| | management for the resource. |

As may be seen from the above exemplary table of the DC schema, the DC schema may define certain properties, and in some cases the format of those properties. Other schemas may define properties with like names, yet different descriptions or forms. The DC schema property ‘Date’ may be defined to have the form “YYYY-MM-DD;” however, programming languages such as Java, C++, C# and the like, may define ‘Date’ in a different form, or in a different order. In one programming language, a predefined form for property ‘Date’ may be a string. In yet another language, the property ‘Date’ may be a series of integer values, and having an order comprising a leading month, followed by a day, and then a year. In designing programs (using programming languages such as Java, C++, C#, and the like) to access METADATA in RDF based storage system, it may be necessary to ensure that data types returned from the access are type-safe. ‘Type-safe’ may mean that in performing the access to the METADATA database data types may be converted to match the defined type in the target language. The embodiments of the invention, discussed more fully below, address possible concerns regarding type-safe APIs.

There may be many pre-defined and publicly available schemas, DC being just one example. Each of these schema may define many properties for the particular type of resource for which the schema was created. Each of the property types may lead to an access routine. For example, the DC schema illustrated above may give rise to fifteen distinct routines for reading METADATA within an RDF based database using the DC schema. Two examples may be a “get.date” program and a “get.author” program. However, manual creation of these exemplary programs may be overly time consuming for a programmer needing access to only a single or a few pieces of information.

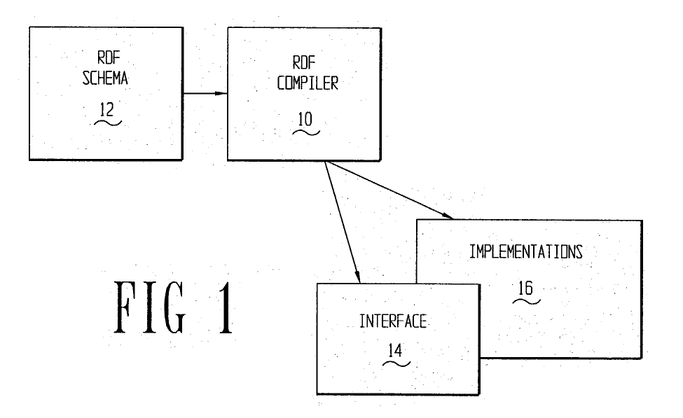

Embodiments of the present invention may produce routines for type-safe access to databases coded using the RDF model, RDF leveraged databases, for any of a variety of programming languages, such as, but without limitation, Java, C++, C# and the like. More particularly, embodiments of the invention may take the form of a compiler that may access RDF schema, and may produce a native-language application program interface (API) and series of native-language, type-safe implementations based on the properties defined in the schema. The implementations may likewise be referred to as programs, routines and/or bindings. FIG. 1 illustrates, in block diagram form, representative embodiments. In particular, representative embodiments may comprise a compiler 10. The compiler 10 may be an executable program, programmed in any available programming language. The compiler 10 may be designed and coded such that it takes as input data an RDF schema 12. The RDF schema may be a pre-defined and publicly available, such as the DC schema, or may be a schema defined by an individual or organization for a special internal purpose. Regardless of the source schema, the compiler 10 may read the schema 12, may produce an interface 14 from the properties defined, and may also produce a set of native-language implementations 16.

In embodiments of the invention, the interface 14 may be a list of available implementations as produced for the particular schema analyzed by the compiler 10. The number of available APIs listed in an interface such as interface 14 may be related to the number of properties defined in the schema, and the number of operations to be performed. In embodiments of the present invention, there may be four routines for each property defined in the schema. For purposes of illustration, consider a generic schema property herein labeled “Property.” This generic property may thus give rise to the implementations whose calling nomenclature may be exemplified in Table 2:

TABLE 2

| Routine | Purpose |
|---|---|
| Void add Property (type value) | May add to the end of the property |
| | value collection. |
| Collection getProperty ( ) | May get all property and sub-property |
| | values as defined by the RDF schema. |
| Void setProperty (type value) | May set the property of the resource |
| | (replace existing value, if any). If the |
| | resource has more than one property of |
| | the Property type, may return an error. |
| Type getFirstProperty ( ) | May return the first value of a property, |
| | or null in none exist. |

The compiler 10 of the various embodiments may also produce native-language implementations 16. “Native-language implementations” may mean that a compiler 10 in accordance with at least some embodiments of the invention may not produce executable software; rather, the compiler 10 may produce the implementations in their native language. For example, if compiler 10 is designed to inspect an RDF schema 12 and produce Java APIs based on the properties defined, then in at least some embodiments of the invention the compiler may produce not only the interface 14, but may also produce the implementations in Java language—native-language implementations. In this way, the implementations are not hardware dependant. A user may then compile the native-language implementations using a hardware specific compiler. In alternative embodiments of the invention, however, the compiler 10 may produce hardware specific executable code. The implementations 16 produced by the compiler 10 may be designed to be executed (once compiled), read and/or modify METADATA within an RDF leveraged database, and return values (if necessary for the function performed). In embodiments of the invention, it is the implementations 16 that perform any necessary type conversions to ensure that data returned from the routines is type-safe.

There are many possible native languages into which the compiler may create the API 14 and implementation 16 for a specific RDF schema 12. For example, and without limitation, the languages may comprise Java, C++, C#, and like currently existing languages, as well as programming languages that have yet to be developed.

The above discussion is meant to be illustrative of the principles and various embodiments of the present invention. Numerous variations and modifications will become apparent to those skilled in the art once the above disclosure is fully appreciated. For example, the compiler 10 of embodiments of the invention may take input an RDF schema 12; however, alternative embodiments may read RDF leveraged METADATA, rather than an underlying schema, to divine an API and native-language implementations. In embodiments where RDF leveraged METADATA is used as an input to the compiler 10, it is noted that the API 14 and corresponding native-language implementations may not list and contain respectively an implementation for every property of the schema used in the METADATA set identified in the RDF leveraged METADATA, but instead possibly only those utilized in the METADATA coded based on the RDF model. Further, the compiler 10 need not be limited to producing native-language implementations for only a single language; rather, a single compiler program, such as compiler 10, may be programmed to produce the native-language implementations for any of a variety of programming languages. It is intended that the following claims be interpreted to embrace all such variations and modifications.

What is claimed is:

1. A method comprising:
reading a Resource Description Framework (RDF) based input source by a compiler; and
generating a set of implementations by the compiler based on the RDF based input source.

2. The method as defined in claim 1 further comprising generating an interface by the compiler.

3. The method as defined in claim 1 wherein reading the RDF based input source further comprises reading a RDF schema.

4. The method as defined in claim 1 wherein reading the RDF based input source further comprises reading a database coded under an RDF model.

5. The method as defined in claim 1 wherein generating a set of implementations by the compiler further comprises generating a Java native-language set of implementations by the compiler.

6. The method as defined in claim 1 wherein generating the implementations by the compiler further comprises generating a C++ native-language set of implementations by the compiler.

7. The method as defined in claim 1 wherein generating the implementations by the compiler further comprises generating a C# native-language set of implementations by the compiler.

8. The method as defined in claim 1 wherein generating the implementations by the compiler further comprises generating a set of type-safe implementations by the compiler.

9. The method as defined in claim 8 wherein generating a set of type-safe implementations by the computer further comprises generating a set of type-safe native-language implementations by the compiler.

10. A computer readable medium comprising an executable program, the executable program capable of performing tasks when executed, comprising:
reading a Resource Description Framework (RDF) based input source;
generating a list of routines based on properties of the RDF leveraged input source; and
generating a set of routines based on the properties of the RDF based input source.

11. The computer readable medium as defined in claim 10 wherein the reading the RDF based input source task of the executable program further comprises reading an RDF schema.

12. The computer readable medium as defined in claim 10 wherein the reading the RDF based input source task of the executable program further comprises reading a METADATA set coded based on an RDF model.

13. The computer readable medium as defined in claim 10 wherein the generating a set of routines based on the properties of the RDF based input source further comprises generating a Java native-language set of routines.

14. The computer readable medium as defined in claim 10 wherein the generating a set of routines based on the properties of the RDF based input source further comprises generating a C++ native-language set of routines.

15. The computer readable medium as defined in claim 10 wherein the generating a set of routines based on the properties of the RDF based input source further comprises generating a C# native-language set of routines.

16. The computer readable medium as defined in claim 10 wherein the tasks the executable program is adapted to perform further comprise generating a set of type-safe routines.

17. The computer readable medium as defined in claim 16 wherein the generating the set of type-safe routines task further comprises generating a set of type-safe native-language routines.

18. A method comprising:
reading a Resource Description Framework (RDF) based input source by a compiler program;
generating an interface by the compiler program based on the RDF based input source; and
generating a set of native-language bindings by the compiler program.

19. The method as defined in claim 8 wherein reading the RDF based input source further comprises reading a RDF schema document.

20. The method as defined in claim 18 wherein reading the RDF based input source further comprises reading a database based on an RDF model.

21. The method as defined in claim 18 wherein generating a set of native-language bindings by the compiler program further comprises generating a Java native-language set of bindings by the compiler.

22. The method as defined in claim 18 wherein generating a set of native-language bindings by the compiler program further comprises generating a C++ native-language set of bindings by the compiler.

23. The method as defined in claim 18 wherein generating a set of native-language bindings by the compiler program further comprises generating a C# native-language set of bindings by the compiler.

24. The method as defined in claim 18 wherein generating the native-language APIs by the compiler further comprises generating a set of type-safe bindings by the compiler.
